(19) United States
(12) Patent Application Publication
(10) Pub. No.: US 2003/0039606 A1
(43) Pub. Date: Feb. 27, 2003

(54) Process for production of ammonium thiosulphate

(75) Inventors: Peter Schoubye, Horsholm (DK); Kurt Agerbaek Christensen, Birkerod (DK)

Correspondence Address: OSTROLENK FABER GERB & SOFFEN, 1180 AVENUE OF THE AMERICAS, NEW YORK, NY, 100368403

(73) Assignee: Haldor Topsoe A/S

(21) Appl. No.: 09/938,519

(22) Filed: Aug. 27, 2001

(51) Int. Cl. C01B 17/64

(52) U.S. Cl. 423/514

(57) ABSTRACT

A process for production of ammonium thiosulphate (ATS) from H₂S, NH₃ and SO₂, comprising producing ATS in a first absorption step by treating a first stream comprising H₂S and NH₃ with more than 0.3 mole H₂S per mole NH₃ with a solution containing ATS and ammonium sulphite, said solution being produced, in a second absorption step, by treating part of the solution from the first absorption step with a second gas stream gas stream comprising SO₂. The second gas stream is obtained by combusting the H₂S-containing off gas from the first absorption step supplemented with H₂S-containing gas imported from other sources and/or by importing SO₂-containing off gas streams from other souses. The content of NH₃ in the off gas from the second absorber may be decreased by adding the equivalent amount of SO₂ to the off gas upstream of an aerosol filter removing the NH₃ and SO₂ as a solution of NH₄HSO₃, which is fed to the first or second absorber, while the off gas from the filter is passed to the atmosphere.

### BACKGROUND OF THE INVENTION

The present invention relates to a process for production of ammonium thiosulphate (ATS) from H₂S and mixtures of H₂S and NH₃ such as sour water stripper gas in refineries.

It is known to produce aqueous solutions of ATS by reacting a solution of ammonium sulphite with sulphur in liquid form, or with sulphides or polysulfides in aqueous solution as described in Kirk-Other Encyclopaedia of Chemical Technology, 4^{th} edition, 1997, vol. 24, page 62, and in U.S. Pat. Nos. 2,412,607; 3,524,724 and 4,478,807.

Furthermore, it is known from U.S. Pat. No. 3,431,070 to produce ATS in a continuous process from gaseous feed streams comprising H₂S, NH₃ and SO₂. By the process of this patent, ATS and sulphur is produced from a first feed gas stream comprising H₂S and NH₃ and a second feed gas stream comprising SO₂ in three absorption steps. In a first absorber, NH₃ and H₂S are separated into a H₂S off-gas stream and an NH₃-rich solution of ATS. The main part of the solution is passed to a second absorber, in which it is contacted with the SO₂-rich feed gas stream under formation of an off-gas that is vented and a solution rich in ATS and ammonium sulphites. This solution is contacted in a third absorber with the H₂S-gas from the first absorber and, optionally, with additional H₂S. After removal of sulphur formed in the third absorber, the major part of the ATS-solution formed in the third absorber is recycled to the first absorber, while a minor part is mixed with a fraction of the NH₃-rich solution of ATS formed in the first absorber forming the product solution of ATS. There are three major disadvantages of this process: Elementary sulphur is formed in the third absorber and must be separated from the solution, the off-gas vented from the third absorber has a high concentration of H₂S and the process is complicated with three integrated absorption steps.

It is also known from U.S. Pat. No. 6,159,440 to produce an aqueous solution of ATS from gaseous feed streams comprising one or two absorbers in series. By this process, a concentrated solution of ammonium hydrogen sulphite (AHS) is produced from NH₃ and SO₂ in a first absorption step comprising one or two absorbers in series. The solution is then contacted in a second absorption step with a gaseous mixture of H₂S and NH₃ forming the product solution of ATS. This process requires import of NH₃.

The general object of this invention is to provide an improved process for the production of ATS in which over 99.9% of all sulphur and all NH₃ in the feed streams for the process are recovered as ATS without the use of additional NH₃.

### SUMMARY OF THE INVENTION

Accordingly, the present invention is a process for continuous production of ammonium thiosulphate (ATS) from H₂S, NH₃ and SO₂, comprising contacting, in a first absorption step, a first feed stream containing NH₃ and more than 0.3 mole H₂S per mole NH₃ with an aqueous solution containing ATS and ammonium hydrogen sulphite (AHS), the aqueous solution being produced by contacting, in a second absorption step, a second feed gas stream comprising SO₂ with part of the solution comprising ATS and NH₃ produced in the first absorption step, the remaining part of said solution being exported from the process as the product ATS solution.

### BRIEF DESCRIPTION OF THE DRAWINGS

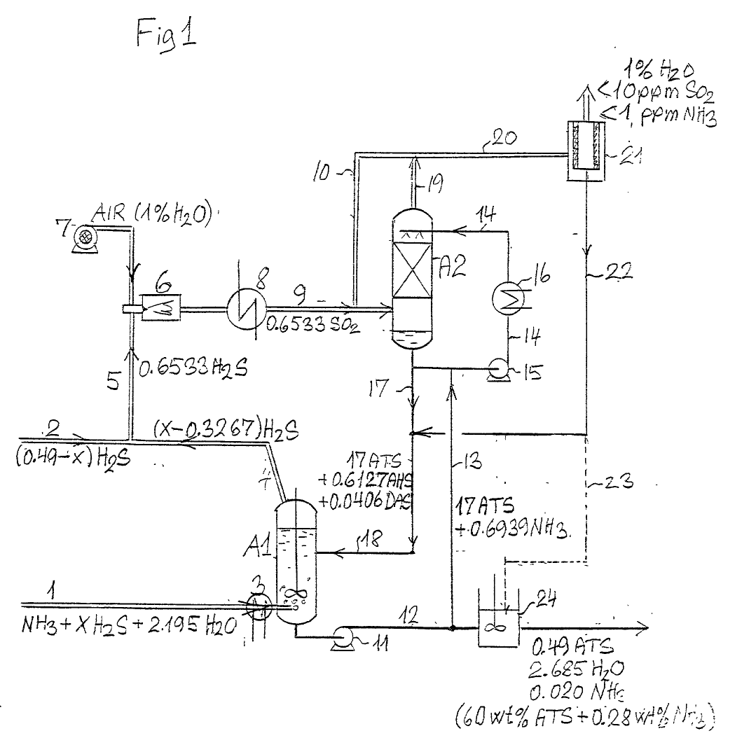

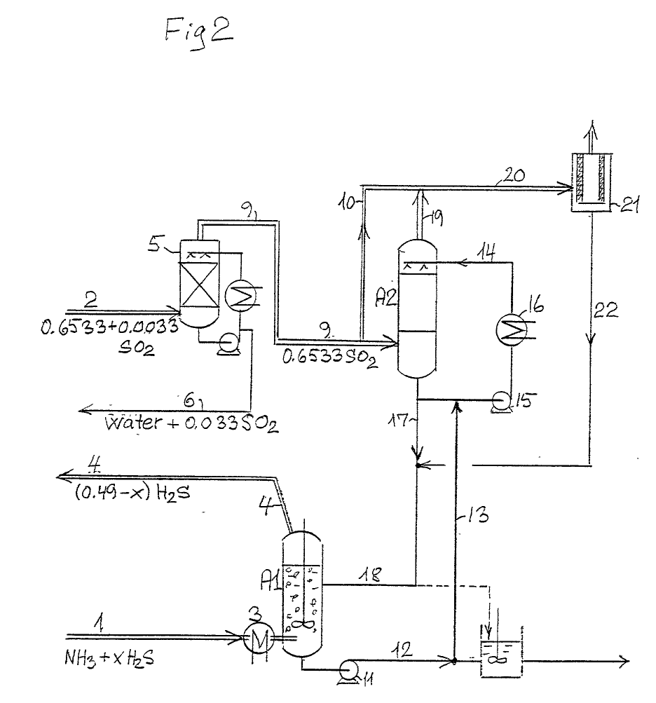

In the appended drawings, FIGS. 1 and 2 are flow sheets illustrating embodiments of the process.

### DESCRIPTION OF THE PREFERRED EMBODIMENTS

The following examples are illustrative of the process.

### EXAMPLE 1

A preferred embodiment of the process according to the invention, wherein a first feed stream comprising both NH₃ and H₂S and second feed stream comprising H₂S without NH₃ is treated is shown in schematically in FIG. 1. The numbers shown in FIG. 1 refer to mass balances, expressed in molar units, based on the simplified assumption that 1 mole NH₃ in the first feed stream and 0.98 mole H₂S in the first and second feed streams are recovered as 0.49 mole ATS in a product solution composed of 60 wt % ATS+0.28 wt % NH3+balance H₂O. The stoicheometric of the overall process then becomes NH₃+0.98H₂S+0.9802+2.195H₂O=0.49ATS+2.685H₂O+0.020NH₃. The oxygen is supplied as ambient air for combusting 0.6533 mole H₂S to SO₂, as will shown below. The three components to the right represent the 121.3 g/mole NH₃ of product solution composed of 60% ATS, 0.28% NH₃ and balance H₂O.

In practice, the product ATS-solution also comprises about 1% (NH₄)₂SO₄ (originating from oxidation of SO₂ to SO₃ in the combustion of H₂S) and 0.1-1% (NH₄)₂SO₃ (DAS), and the concentrations of ATS and NH₃ may vary in the range 55-60% and 0.1-0.8%, respectively. These variations do not change the principles of the process, as described below.

The first feed stream in line 1 composed of 1 mole NH₃, x mole H₂S and 2.195 mole H₂O (assuming that all H₂O for the process is added with the first feed stream) is preferably condensed in a cooler 3 at a temperature below 40° before being supplied to the first absorber A1 in which H₂S and NH₃ reacts with 0.6533 mole (ammonium hydrogen sulphite diammonium sulphite) forming ATS:

2H₂S+2NH₃+4NH₄HSO₃=3(NH₄)₂S₂O₃+3H₂O (1-1)

2H₂S+4(NH₄)₂SO₃=3(NH₄)₂S₂O₃+2NH₃+3H₂O (1-2)

Excess NH₃ of (1-0.3267) mole NH₃ is dissolved in the ATS-solution, while excess H₂S of (x-0.3267) mole H₂S leaves A1 in line 4. The ATS-solution produced in A1 contains 60 wt % ATS and 0.28 wt % NH₃ and is passed in lines 12 and 13 to recycle loop 14 of the second absorber A2.

The optimal pH for the reactions in A1 is in the range 8.0-8.2. Lower pH tends to decrease the reaction rate so that the content of unreacted sulphite in the product stream increases. Higher pH tends to give sulphides (NH₄HS) in the product ATS solution which can be reacted to ATS by adding small amounts of AHS-rich ATS solution from line 22 or 18 to the product ATS solution in product tank 24.

The second feed stream of (0.98-x) mole H₂S in line 2 is mixed with the (x-0.3267) mole H₂S off gas in line 4 and supplied through line 5 to the burner 6, where H₂S is burned to give 0.6533 mole SO₂ with combustion air supplied from the blower 7:

2H₂S+3O₂=2SO₂+2H₂O. (3)

The SO₂-rich gas is passed in line 9 to the second absorber A2, in which the SO₂ is absorbed in the form of AHS and DAS by the content of about 0.28% NH₃ contained in the ATS solution produced in A1:

SO₂+NH₃+H₂O=NH₄HSO₃ (4-1)

SO₂+2NH₃+H₂O=(NH₄)₂SO₃ (4-2)

The ATS-solution comprising AHS and a smaller amount of DAS is recycled in line 17 and 18 to A1 in which the AHS and DAS react according to (2-1) and (2-2).

The minimum rate of recycle of ATS-solution between A1 and A2 is determined by the concentration of NH₃ in the product ATS-solution being recycled and by the amount of NH₃ required for formation in A2 of the ammonium sulphite required for the formation of ATS in A1. ATS is not stable in solutions with pH below 6. Hence, the absorption of SO₂ in A2 must take place at a pH above 6.0, which means that there will be a significant slip of NH₃ in the off gas in line 19 from A2.

This NH₃-slip is recovered and recycled to the process by bypassing in line 10 an amount of SO₂ equivalent to the amount of NH₃ in line 19 and mixing the two gas streams upstream of an aerosol filter 21 in which the AHS formed is removed from the gas phase and returned in line 22 to the sulphite loaded recycle stream at 17. The resulting recycle stream contains 0.6533 mole sulphite with a ratio of AHS to DAS of 15.1 which corresponds to pH=6.0.

The amount of NH₃ required for formation of the corresponding amounts of AHS and DAS is determined as 0.6963 mole NH₃ while the relative amount of NH₃ in the ATS product being passed to the product tank 24 is 0.02 mole NH₃. Thus, the recycle ratio is 0.6963/0.02=35, which means that 35 kg ATS solution are recycled per kg of product ATS solution being passed to product tank 24.

The pH value and the concentration of NH₃ in the ATS solution from A1 increases with decreasing ratio between NH₃ in the first feed stream and H₂S in the first and the second feed stream, while the pH in A2 increases with increasing recycle ratio and with increasing pH of the product ATS-solution.

### EXAMPLE 2

A first feed stream comprising 1 mole NH₃+x mole H₂S, where x>0.33 is in this example, as seen in FIG. 2, combined with a second feed stream in line 2 comprising 0.6533 mole SO₂ diluted in a gas stream with a relatively high content of H₂O. The second feed stream is off gas from a Claus plant with 0.5-1% SO₂ and 20-30% H₂O, after oxidation of the combustible in the gas to SO₂, CO₂ and H₂O.

In order to reduce the input of H₂O to the process so that 55-60% ATS solution can be produced directly as in Example 1, the second feed stream is cooled and most of the H₂O condensed by scrubbing the second feed gas stream in scrubber 5 with circulating cold water upstream of the second absorber. About 0.5% of the SO₂ in the second feed stream will be dissolved and contained in the stream of condensed water in line 6. It is recovered by aerating the condensed water in a separate apparatus not shown in FIG. 2. Excess of H₂S from the first absorber is returned in line 4 to the main H₂S gas stream so that no H₂S-burner and boiler are needed.

The concentration of excess NH₃ in the product ATS solution is controlled by controlling the flow of SO₂ in the second feed stream, when the flow and composition of the first feed stream is given.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A process for the continuous production of ammonium thiosulphate (ATS) from H₂S, NH₃ and SO₂, comprising contacting, in a first absorption step, a first feed stream containing NH₃ and more than 0.3 mole H₂S per mole NH₃ with an aqueous solution containing ATS and ammonium hydrogen sulphite (AHS), said aqueous solution being produced by contacting, in a second absorption step, a second feed gas stream comprising SO₂ with part of the solution comprising ATS and NH₃ produced in the first absorption step, the remaining part of said solution being withdrawn from the process as the product ATS solution.

2. A process of claim 1, wherein the second feed stream is produced by combusting an excess stream of H₂S emitted from the first absorption step supplemented with additional H₂S, so that the stream of H₂S in the first feed stream plus the stream of additional H₂S being combusted for producing the flow of SO₂ contained in the second feed gas stream constitutes 0.9-1 mole H₂S per mole of NH₃ in the first feed stream.

3. A process of claim 2, wherein the stream of H₂S in the first feed stream plus the stream of additional H₂ being combusted for producing the flow of SO₂ contained in the second feed gas stream constitutes 0.97-0.99 mole H₂S per mole of NH₃ in the first feed stream.

4. A process of claim 1, wherein the second feed gas stream comprising SO₂ is made up entirely or partly of an imported stream of gas comprising SO₂ supplemented with SO₂ produced by combusting H₂S so that the flow of SO₂ contained in the second feed gas stream constitutes 0.9-1, mole SO₂ per mole NH₃ in the first feed stream.

5. A process of claim 4, wherein the flow of SO₂ contained in the second feed stream constitutes 0.97-0.99 mole SO₂ per mole NH₃ is the first feed stream.

6. A process of claim 1, wherein the first absorption step is in a liquid phase stirred reactor in which the first feed stream is introduced as a condensate.

7. A process of claim 1 in which the second absorption step is in a fixed bed packed absorber followed by addition of a fraction of the SO₂-containing gas to the off gas from said absorber upstream of an aerosol filter removing from the off gas the content of AHS being formed as aerosol by the reaction between NH₃ in the off gas and the SO₂ added to the off gas.

8. A process of claim 1, wherein the pH of the solution containing ATS and NH₃ produced in the first absorption step is maintained in the range 7-9 by adjusting the ratio between the total flow of H₂S+SO₂ imported to the process and the flow of NH₃ imported the first feed stream, within a range of 0.9-1 mole (H₂S+SO₂) per mole NH₃.

9. A process of claim 8, wherein the pH of the solution containing ATS and NH₃ produced in the first absorption step is maintained in the range 7.90-8.3.

10. A process of claim 8, wherein the ratio between the total flow of H₂S+SO₂ imported to the process and the flow of NH₃ imported to the first feed stream is adjusted to within a range of 0.97-0.99 mole (H₂S+SO₂) per mole NH₃.

11. A process of claim 1, wherein the pH of the solution containing ATS and AHS is maintained within the range 5.6-7.5 by adjusting the ratio between the flow of product ATS solution comprising ATS and NH₃ being recycled to the second absorption step, and the flow of product ATS is passed to a product tank.

12. A process of claim 11, wherein the pH of the solution containing ATS and AHS is maintained within the range of 5.9-6.3.
